(19) United States
(12) Patent Application Publication
(10) Pub. No.: US 2019/0264784 A1
(43) Pub. Date: Aug. 29, 2019

(54) BALL ASSEMBLY FOR A BALL-TYPE CONTINUOUSLY VARIABLE PLANETARY TRANSMISSION

(71) Applicant: Dana Limited, Maumee, OH (US)

(72) Inventors: Joseph J. Horak, Austin, TX (US); Jeremy M. Kaiser, Leander, TX (US); Ryan D. Nelms, Austin, TX (US)

(21) Appl. No.: 16/275,583

(22) Filed: Feb. 14, 2019

Related U.S. Application Data
(60) Provisional application No. 62/635,761, filed on Feb. 27, 2018.

(51) Int. Cl. F16H 15/50; F16H 55/32; F16H 57/08

(52) U.S. Cl. CPC F16H 15/503; F16H 2057/085; F16H 57/08; F16H 55/32

(57) ABSTRACT

Provided herein is a ball assembly for a continuously variable transmission (CVT) having a ball having an inner bore, a ball axle aligned in the inner bore, and an angular contact bearing coupled to the inner bore and the ball. Additionally provided herein is a continuously variable transmission (CVT) including a plurality of the ball assemblies, a first traction ring assembly in contact with each ball, and a second traction ring assembly in contact with each ball.

### RELATED APPLICATION

This application claims benefit of and priority to U.S. Provisional Application Ser. No. 62/635,761 filed on Feb. 27, 2018 which is incorporated by reference in its entirety herein.

### BACKGROUND

Automatic and manual transmissions are commonly used on automobiles. Such transmissions have become more and more complicated since the engine speed has to be adjusted to limit fuel consumption and the emissions of the vehicle. A vehicle having a driveline including a tilting ball variator allows an operator of the vehicle or a control system of the vehicle to vary a drive ratio in a stepless manner. A variator is an element of a Continuously Variable Transmission (CVT) or an Infinitely Variable Transmission (IVT). Transmissions that use a variator can decrease the transmission's gear ratio as engine speed increases. This keeps the engine within its optimal efficiency while gaining ground speed, or trading speed for torque during hill climbing, for example. Efficiency in this case can be fuel efficiency, decreasing fuel consumption and emissions output, or power efficiency, allowing the engine to produce its maximum power over a wide range of speeds. That is, the variator keeps the engine turning at constant RPMs over a wide range of vehicle speeds.

### SUMMARY

Provided herein is a ball assembly for a continuously variable transmission (CVT) including: a ball having an inner bore; a ball axle aligned in the inner bore; an angular contact bearing coupled to the inner bore and the ball axle; and an axle roller coupled to the ball axle.

In some embodiments of the ball assembly, the angular contact bearing further includes an inner race coupled to the ball axle.

In some embodiments of the ball assembly, the ball axle further includes a shoulder, wherein the inner race is positioned between the shoulder of the ball axle and the angular contact bearing.

In some embodiments of the ball assembly, the angular contact bearing further includes an outer race.

In some embodiments of the ball assembly, the outer race is integral to the inner bore of the ball.

In some embodiments of the ball assembly, the axle roller is retained to the ball axle by a swaging process.

In some embodiments of the ball assembly, the axle roller is integral to the ball axle.

Provided herein is a continuously variable transmission (CVT) having: a plurality of ball assemblies having a ball having an inner bore, a ball axle aligned in the inner bore, an angular contact bearing coupled to the inner bore and the ball axle, and an axle roller coupled to the ball axle; a first traction ring assembly in contact with each ball; and a second traction ring assembly in contact with each ball.

Provided herein is a ball assembly for a continuously variable transmission (CVT) having a ball having a tiltable axis of rotation, a counter bore formed in the ball, the counter bore aligned with the tiltable axis of rotation, an axle roller coaxial with the tiltable axis of rotation, and an angular contact bearing coupled to the counter bore and the axle roller.

In some embodiments of the ball assembly, the angular contact bearing further includes an inner race formed in the counter bore.

In some embodiments of the ball assembly, the angular contact bearing further includes an outer bore formed in the axle roller.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features are set forth with particularity in the appended claims. A better understanding of the features and advantages of the present embodiments will be obtained by reference to the following detailed description that sets forth illustrative embodiments, in which the principles of the preferred embodiments are utilized, and the accompanying drawings of which:

FIG. 1 is a side sectional view of a ball-type variator.

FIG. 2 is a plan view of a carrier member that is used in the variator of FIG. 1.

FIG. 3 is an illustrative view of different tilt positions of the ball-type variator of FIG. 1.

FIG. 4 is a cross-sectional plan view of a ball assembly for a ball-type continuously variable transmission.

FIG. 5 is an isometric cross-sectional view of the ball assembly of FIG. 4.

FIG. 6 is a cross-section plan view of a ball assembly for a ball-type continuously variable transmission.

### DETAILED DESCRIPTION OF THE PREFERRED EMBODIMENTS

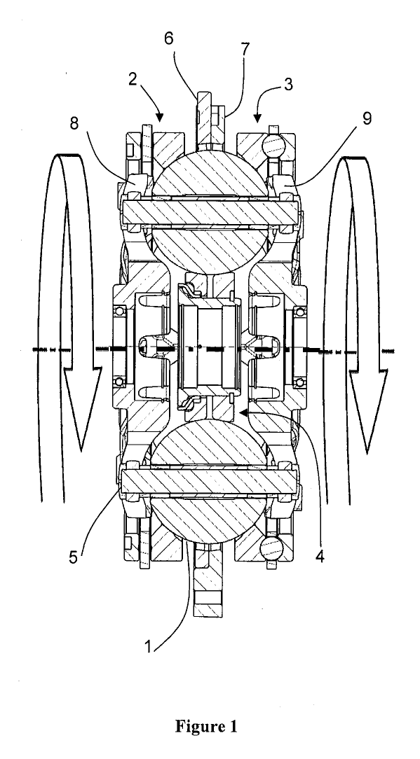

Provided herein are configurations of CVTs based on ball-type variators, also known as CVPs, for continuously variable planetary. Basic concepts of a ball-type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface contact with the balls 1, as a first traction ring 2 and a second traction ring 3, and an idler (sun) assembly 4 as shown on FIG. 1. The balls 1 are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is substantially fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9. The radial guide slots 8 and the radially offset guide slots 9 are adapted to guide the tiltable axles 5. The axles 5 are adjusted to achieve a desired ratio of input speed to output speed during operation of the CVT.

In some embodiments, adjustment of the axles 5 involves control of the position of the first carrier member and the second carrier member to impart a tilting of the axles 5 and thereby adjusts the speed ratio of the variator. Other types of ball CVTs also exist, like the one produced by Milner, but are slightly different.

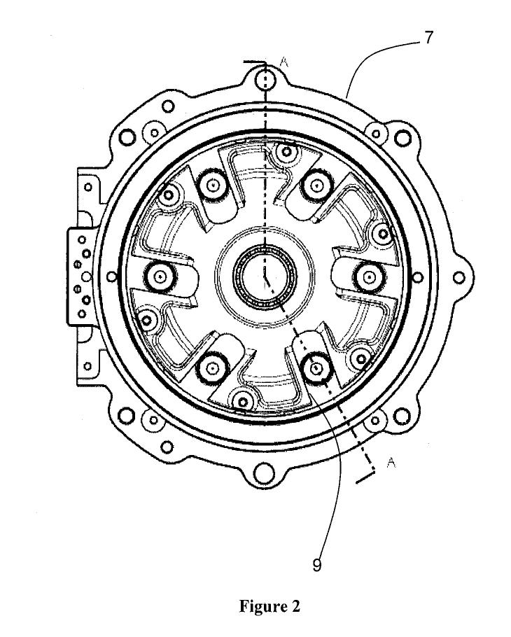

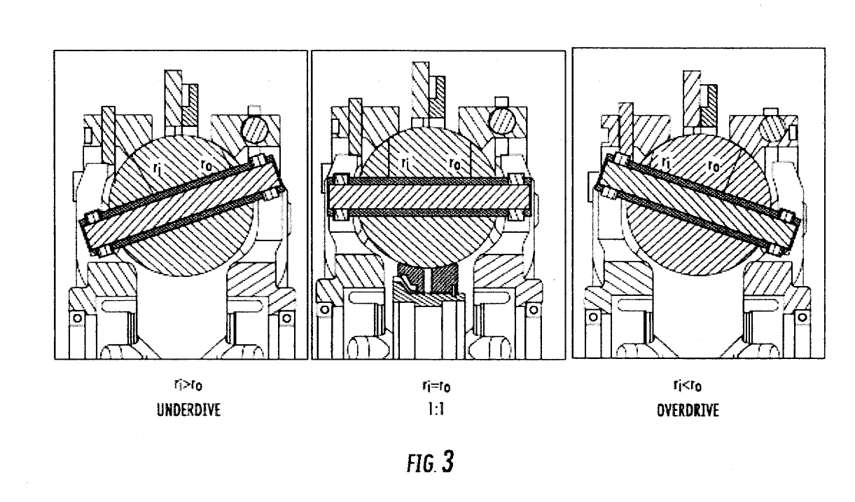

The working principle of such a CVP of FIG. 1 is shown on FIG. 2. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments disclosed here are related to the control of a variator and/or a CVT using generally spherical planets each having a tiltable axis of rotation that is capable of being adjusted to achieve a desired ratio of input speed to output speed during operation.

In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected”, “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe the embodiments, specific structures or mechanisms that link or couple the elements are typically described. However, unless otherwise specifically stated, when one of said terms is used, the term indicates that the actual linkage or coupling may take a variety of forms, which in certain instances will be readily apparent to a person of ordinary skill in the relevant technology.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator.

It should be noted that reference herein to “traction” does not exclude applications where the dominant or exclusive mode of power transfer is through “friction.” Without attempting to establish a categorical difference between traction and friction drives here, generally these may be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction forces, which would be available at the interfaces of the contacting components and is a measure of the maximum available drive torque.

In some embodiments, the traction coefficient is a design parameter in the range of 0.3 to 0.6.

Typically, friction drives generally relate to transferring power between two elements by frictional forces between the elements. For the purposes of this disclosure, it should be understood that the CVTs described here may operate in both tractive and frictional applications. As a general matter, the traction coefficient μ is a function of the traction fluid properties, the normal force at the contact area, and the velocity of the traction fluid in the contact area, among other things. For a given traction fluid, the traction coefficient μ increases with increasing relative velocities of components, until the traction coefficient μ reaches a maximum capacity after which the traction coefficient μ decays. The condition of exceeding the maximum capacity of the traction fluid is often referred to as “gross slip condition”.

As used herein, “creep”, “ratio droop”, or “slip” is the discrete local motion of a body relative to another and is exemplified by the relative velocities of rolling contact components such as the mechanism described herein. In traction drives, the transfer of power from a driving element to a driven element via a traction interface requires creep. Usually, creep in the direction of power transfer is referred to as “creep in the rolling direction.” Sometimes the driving and driven elements experience creep in a direction orthogonal to the power transfer direction, in such a case this component of creep is referred to as “transverse creep.”

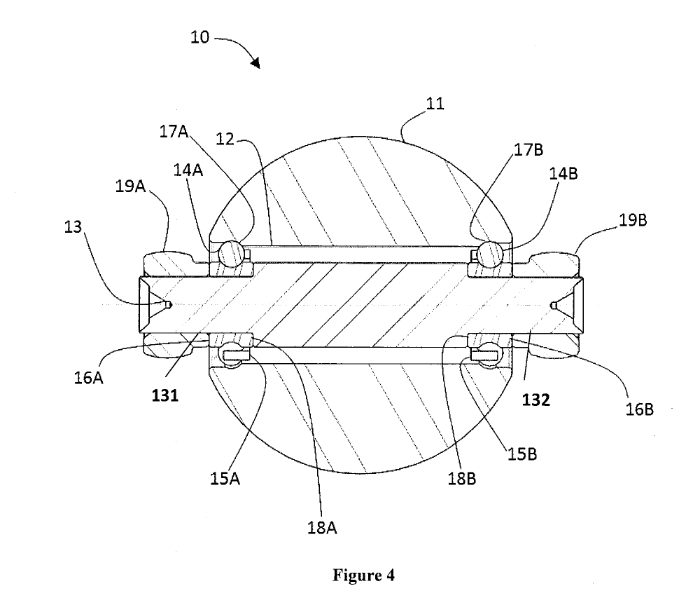

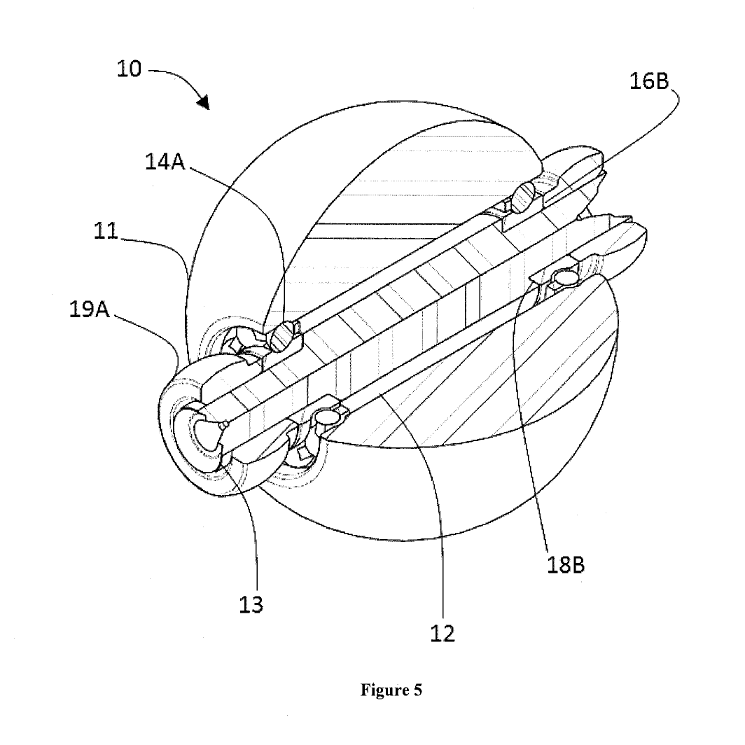

Referring now to FIGS. 4 and 5, in some embodiments, a ball assembly 10 is implementable in the variator depicted in FIGS. 1-3.

In some embodiments the ball assembly 10 includes a ball 11 having a central bore or inner bore 12 and a ball axle 13 positioned within the inner bore 12.

In some embodiments, the ball axle 13 is supported in the inner bore 12 with an angular contact bearing 14.

In some embodiments, an angular contact bearing 14A is positioned near a first end of the inner bore 12 and an angular contact bear 14B is positioned near a second end of the inner bore 12. For clarity and conciseness, at times similar components labeled similarly (for example, angular contact ball bearing 14A and angular contact ball bearing 14B) will be referred to collectively by a single label (for example, angular contact ball bearing 14).

In some embodiments, the angular contact bearing 14 is provided with a roller cage 15 and an inner race 16. The angular contact bearing 14 has an outer race 17.

In some embodiments, the outer race 17 is integral to the inner bore 12.

In some embodiments, the ball axle 13 is provided with a shoulder 18. The shoulder 18 is configured to axially position the inner race 16 along the ball axle 13.

As shown in FIG. 4, in some embodiments, the shoulders 18A, 18B are positioned on the axial ends thereof and contact the inner race 16. The inner race 16 is positioned between the shoulder 18 and the angular contact bearing 14.

In some embodiments, the shoulders 181, 182 create narrow portions 131, 132 of the axle 13 on the axial ends thereof.

Each end of the ball axle 13 is provided with an axle roller 19 adapted to couple the ball assembly to the carrier assembly, for example, but not limited to, the first carrier member 6 and the second carrier member 7.

In some embodiments, the angular contact bearing 14 is configured to have a contact angle between the inner race 16 and the outer race 17 in the range of, but not limited to, 15 degrees to 40 degrees, for precision races.

In some embodiments, the ball axle 13 is composed from a mild steel material.

In some embodiments, the axle rollers 19 are retained on the ball axle 13 on each axial end of the thereof.

In some embodiments, the axle rollers 19 are retained through a known swaging process on each end of the ball axle 13.

The retention of the axle roller 19 on the ball axle 13 provide the required bearing preload to the angular contact bearings 14.

In some embodiments, the first axle roller 19A is integral to the ball axle 13.

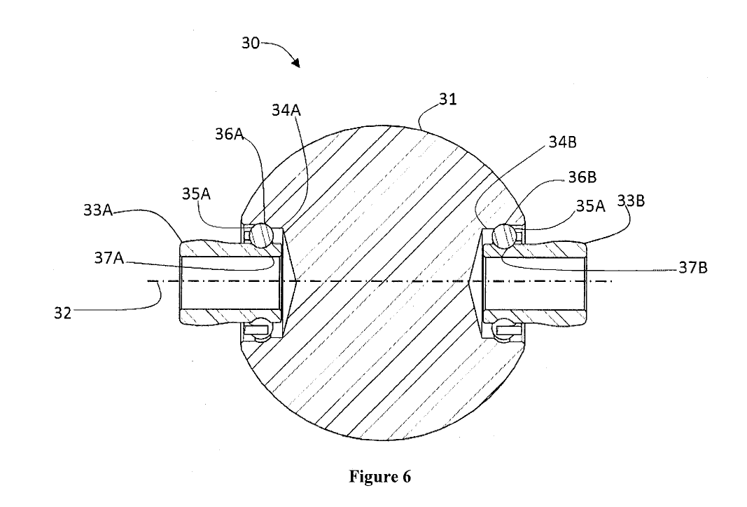

Referring now to FIG. 6, in some embodiments, a ball assembly 30 is implementable in the variator depicted in FIGS. 1-3.

In some embodiments, the ball assembly 30 includes a ball 31 having a tiltable axis of rotation 32. In some embodiments, the ball assembly 30 includes an axle roller 33 aligned with the tiltable axis of rotation 32 and supported in a counter bore 34 by a ball bearing 35.

In some embodiments, a ball bearing 35A is positioned on one end of the tiltable axis of rotation 32, and a ball bearing 35B is positioned near a second end of the tiltable axis of rotation 32, in such a way that the ball bearing 35A and the ball bearing 35B are coaxial with the tiltable axis of rotation 32.

In some embodiments, the ball bearing 35 is provided with an outer race 36. The ball bearing 35 has an inner race 37.

In some embodiments, the inner race 37 is integral to the axle roller 33.

In some embodiments, the outer race 36 is formed in the counter bore 34 of the ball 31.

In some embodiments, the axle roller 33 is composed of a mild steel material.

The foregoing description details certain embodiments. It will be appreciated, however, that no matter how detailed the foregoing appears in text, the preferred embodiments can be practiced in many ways. As is also stated above, it should be noted that the use of particular terminology when describing certain features or aspects of the preferred embodiments should not be taken to imply that the terminology is being re-defined herein to be restricted to including any specific characteristics of the features or aspects of the embodiments with which that terminology is associated.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the embodiments described herein may be employed in practice. It is intended that the following claims define the scope of the preferred embodiments and that methods and structures within the scope of these claims and their equivalents be covered thereby.

What is claimed is:

1. A ball assembly for a continuously variable transmission (CVT) comprising:
a ball having an inner bore;
a ball axle aligned in the inner bore; and
an angular contact bearing coupled to the inner bore and the ball axle.

2. The ball assembly of claim 1, further comprising an axle roller coupled to the ball axle.

3. The ball assembly of claim 1, wherein the angular contact bearing further comprises an inner race coupled to the ball axle.

4. The ball assembly of claim 3, wherein the ball axle further comprises a shoulder, wherein the inner race is positioned between the shoulder of the ball axle and the angular contact bearing.

5. The ball assembly of claim 1, wherein the angular contact bearing further comprises an outer race.

6. The ball assembly of claim 5, wherein the outer race is integral to the inner bore of the ball.

7. The ball assembly of claim 2, wherein the axle roller is coupled to the ball axle by a swaging process.

8. The ball assembly of claim 2, wherein the axle roller is integral to the ball axle.

9. A continuously variable transmission (CVT) comprising:
a plurality of ball assemblies according to claim 2;
a first traction ring assembly in contact with each ball; and
a second traction ring assembly in contact with each ball.

10. A ball assembly for a continuously variable transmission (CVT) comprising:
a ball having a tiltable axis of rotation;
a counter bore formed in the ball, the counter bore aligned with the tiltable axis of rotation;
an axle roller coaxial with the tiltable axis of rotation; and
an angular contact bearing coupled to the counter bore and the axle roller.

11. The ball assembly of claim 10, wherein the angular contact bearing further comprise an inner race formed in the counter bore.

12. The ball assembly of claim 10, wherein the angular contact bearing further comprises an outer bore formed in the axle roller.
